SEQUENCE LISTING (2 sequences)

SEQ ID NO: 1 - protein, 515 aa, Bacillus stearothermophilus
AAPFNGTMMQYFEWYLPDDGTLWTKVANEANNLSSLGITALWLPPAYKGTSRSDVGYGVYDLYDLGEFNQKGTVRTKYGTKAQYLQAIQAAHAAGMQVYADVVFDHKGGADGTEWVDAVEVNPSDRNQEISGTYQIQAWTKFDFPGRGNTYSSFKWRWYHFDGVDWDESRKLSRIYKFRGIGKAWDWEVDTENGNYDYLMYADLDMDHPEVVTELKNWGKWYVNTTNIDGFRLDAVKHIKFSFFPDWLSYVRSQTGKPLFTVGEYWSYDINKLHNYITKTNGTMSLFDAPLHNKFYTASKSGGAFDMRTLMTNTLMKDQPTLAVTFVDNHDTEPGQALQSWVDPWFKPLAYAFILTRQEGYPCVFYGDYYGIPQYNIPSLKSKIDPLLIARRDYAYGTQHDYLDHSDIIGWTREGVTEKPGSGLAALITDGPGGSKWMYVGKQHAGKVFYDLTGNRSDTVTINSDGWGEFKVNGGSVSVWVPRKTTVSTIARPITTRPWTGEFVRWTEPRLVAWP

SEQ ID NO: 2 - protein, 316 aa, Bacillus licheniformis
MVSKKSVKRGLITGLIGISIYSLGMHPAQAAPSPHTPVSSDPSYKAETSVTYDPNIKSDQYGLYSKAFTGTGKVNETKEKAEKKSPAKAPYSIKSVIGSDDRTRVTNTTAYPYRAIVHISSSIGSCTGWMIGPKTVATAGHCIYDTSSGSFAGTATVSPGRNGTSYPYGSVKSTRYFIPSGWRSGNTNYDYGAIELSEPIGNTVGYFGYSYTTSSLVGTTVTISGYPGDKTAGTQWQHSGPIAISETYKLQYAMDTYGGQSGSPVFEQSSSRTNCSGPCSLAVHTNGVYGGSSYNRGTRITKEVFDNLTNWKNSAQ

(19) United States
(12) Patent Application Publication
(10) Pub. No.: US 2017/0210658 A1
(43) Pub. Date: Jul. 27, 2017

(54) Methods for Enhancing the Dewaterability of Sludge with Enzyme Treatment

(71) Applicant: Novozymes A/S, Bagsvaerd (DK)

(72) Inventors: Gregory DeLozier, Raleigh, NC (US); Wanghui Xu, Beijing (CN); Mingjia Zhang, Beijing (CN); Wanghui Zhu, Bagsvaerd (DK)

(73) Assignee: Novozymes A/S, Bagsvaerd (DK)

(21) Appl. No.: 15/500,315

(22) PCT Filed: Sep. 9, 2015
(86) PCT No.: PCT/US2015/049160

§ 371 Date: Jan. 30, 2017

Related U.S. Application Data
(60) Provisional application No. 62/048,058, filed on Sep. 9, 2014.

(51) Int. Cl. C02F 11/14; C02F 3/34

(52) U.S. Cl. CPC C02F 11/14; C02F 3/342

(57) ABSTRACT

The present disclosure relates to enhancing sludge dewaterability by adding an alpha-amylase and protease to the sludge prior to conventional conditioning and dewatering operations.

### REFERENCE TO A SEQUENCE LISTING

This application contains a Sequence Listing in computer readable form, which is incorporated herein by reference.

### FIELD OF THE INVENTION

The present invention relates to methods for enhancing the dewaterability of residuals (i.e. sludge) generated by conventional wastewater treatment operations.

### BACKGROUND OF THE INVENTION

Sludge, generated during the course of conventional wastewater treatment, is usually dewatered or concentrated prior to disposal by incineration, land application, land filling, composting, etc. A basic dewatering scenario involves forming strong, shear-resistant sludge flocs through the addition of a conditioning agent such as ferric sulphate and/or a flocculating agent (e.g. polyelectrolyte) followed by mechanical solid/liquid separation across gravity belt thickeners, belt filter presses, or centrifuges. By dewatering sludge, the wastewater treatment plant (WWTP) enhances the amount of solids per volumetric unit of sludge (i.e. cake solids) that ultimately must be disposed of. The benefits of higher cake solids include: reduced dewatered sludge volume (less sludge to be “managed” by the plant); lower annual transportation costs (shipping the sludge to landfills or sites of land application); less water to be evaporated before sludge can be incinerated (increasing the net energy value of the sludge when incineration is used for cogeneration purposes); a more concentrated feed to digesters; and/or reduced volume of sludge to be landfilled or land applied.

The generic composition of sludge is generally about 90-99% water, the remaining portion being total solids, with actual cell mass (i.e. bacterial cells) representing approximately 10% of the total solids. The remaining 90% of the total solids consists of extracellular polymeric substance (EPS) which forms a hydrated matrix within which the bacterial cells are dispersed. Sludge dewaterability, regardless of the means used to generate the sludge, has been largely associated with the EPS fraction of the whole sludge. EPS is comprised of debris from cell lysis (e.g. nucleic acid, lipids/phospholipids, protein, etc.), actively secreted extracellular products (e.g. polysaccharides and proteins), products of extracellular, EPS-bound enzymatic activity (e.g. polysaccharides), adsorbed material from the wastewater (e.g. humic substances, multivalent cations). Due to this complex nature of EPS and the predominant presence of polysaccharides and protein, EPS is traditionally characterized by the ratio of carbohydrates to proteins (EPS_{carb:prot}). While the EPS_{carb:prot} can vary from primary sludge to primary sludge depending on numerous operational parameters of the WWTP, the EPS composition within secondary sludges is somewhat more digestion specific: anaerobically digested sludge EPS_{carb:prot} tends to be less than unity while aerobically digested sludge EPS_{carb:prot} is greater than unity. In any case, these primary components are considered to be the key hydratable substances within sludge flocs that effectively bind water and resist dewatering.

Methods which disrupt the water-binding capacity and/or mechanical integrity of sludge flocs are believed to enhance the dewaterability of the whole sludge upon polymeric flocculation. Most of such methods have focused on the ability of novel chemistries (e.g. acid pre-treatment, multivalent cationic conditioners) and processes (high temperature pre-treatment, electric discharge, sonication) to disrupt EPS components and improve dewaterability. A number of papers exist describing the use of enzymes for selective hydrolysis within the EPS to reduce the sludge volume, with varying results. See DE10249081, US2003014125, WO9110723, and DE3713739.

Prior art of interest includes U.S. Patent Publication No. US-2008-0190845 (herein incorporated by reference in its entirety) to DeLozier et al. relating to methods for enhancing the dewaterability of residuals (i.e. sludge) generated by conventional wastewater treatment operations. U.S. Pat. No. 4,266,031 (herein incorporated by reference in its entirety) to Tang et al. is also of interest as it relates to protease from Bacillus licheniformis.

As sludge remains problematic and dewatering difficult, there is a continuous need to improve methods for enhancing the dewaterability of residuals (i.e. sludge) generated by conventional wastewater treatment operations.

### SUMMARY OF THE INVENTION

The present disclosure relates to methods for enhancing the dewaterability of sludge including contacting or treating sludge with an enzyme and compositions thereof including an alpha-amylase and protease. In a preferred embodiment, the disclosure relates to methods for enhancing the dewaterability of sludge including treating the sludge with an enzyme composition including AQUAZYME ULTRA 1200 brand enzyme composition from Novozymes A/S (Bagsvaerd, DK). In embodiments, the present disclosure relates to methods for enhancing the dewaterability of sludge comprising contacting the sludge with an enzyme composition including and effective amount of AQUAZYME ULTRA 1200 brand enzyme composition from Novozymes A/S (Bagsvaerd, DK) and an effective/supplemental amount of protease. A non-limiting example of protease includes glutamic acid-specific protease.

In yet another embodiment, the treatment comprises an enzyme composition including an alpha-amylase, a protease such as glutamic acid-specific protease, and at least one additional enzyme, such as, a lipase, a cellulase, a hemicellulase, another protease, an oxidoreductase a laccase, a glycosyl hydrolase and/or an esterase.

The enzyme treatment is preferably added prior to sludge conditioning (i.e., prior to coagulation and/or flocculation) and mechanical dewatering. In embodiments, enzyme and compositions thereof in accordance with the present disclosure is applied to municipal sludge to aid in subsequent mechanical dewatering, resulting in lower sludge volumes, and/or reduced use of polymers used in dewatering process.

In embodiments, the active enzymes in composition of the present disclosure include alpha-amylase from Bacillus stearothermophilus and glutamic acid specific protease constituent. Compositions of the present disclosure surprisingly enhances the dewaterability of residuals compared to alpha-amylase applied alone under similar conditions. In embodiments, a method for enhancing the dewaterability of sludge is disclosed including the step of contacting or adding an alpha-amylase and protease to the sludge, wherein the alpha-amylase has at least 90% sequence identity to the Geobacillus stearothermophilus alpha-amylase shown in SEQ ID NO: 1 and the protease has at least 90% sequence identity to SEQ ID NO: 2. In embodiments, the alpha-amylase has at least 96% sequence identity to the alpha-amylase shown in SEQ ID NO: 1. In embodiments, the alpha-amylase has at least 97% sequence identity to the alpha-amylase shown in SEQ ID NO: 1. In embodiments, the alpha-amylase has at least 99% sequence identity to the alpha-amylase shown in SEQ ID NO: 1. In embodiments, the alpha-amylase comprises or consists of the alpha-amylase shown in SEQ ID NO: 1. In embodiments, the alpha-amylase is the mature form of the alpha-amylase shown in SEQ ID NO: 1 or functional fragments thereof.

In embodiments, the protease has at least 95% sequence identity to SEQ ID NO: 2. In embodiments, the protease has at least 96% sequence identity to SEQ ID NO: 2. In embodiments, the protease has at least 97% sequence identity to SEQ ID NO: 2. In embodiments, the protease has at least 98% sequence identity to SEQ ID NO: 2. In embodiments, the protease has at least 99% sequence identity to SEQ ID NO: 2. In embodiments, the protease comprises or consists of the protease shown in SEQ ID NO: 2. In embodiments, the protease is the mature form of the protease shown in SEQ ID NO: 2 or functional fragments thereof.

In embodiments, the dose of alpha-amylase is between 2 and 140 g per dry ton of total suspended solids and the dose of the protease is between 2 and 140 g per dry ton of total suspended solids. In embodiments, the dose of alpha-amylase is between 2 and 70 g per dry ton of total suspended solids and the dose of the protease is between 2 and 70 g per dry ton of total suspended solids. In embodiments, the dose of alpha-amylase is between 2 and 35 g per dry ton of total suspended solids and the dose of the protease is between 2 and 35 g per dry ton of total suspended solids. In embodiments, the dose of alpha-amylase is between 2 and 8 g per dry ton of total suspended solids. In embodiments, the dose of alpha-amylase is between 2 and 5 g per dry ton of total suspended solids and the dose of the protease is between 2 and 5 g per dry ton of total suspended solids. In embodiments, the alpha-amylase and protease enzyme is allowed to incubate with the sludge for 1 minute to 24 hours.

In embodiments, the alpha-amylase and protease enzyme is allowed to incubate with the sludge for 30 minutes to 12 hours. In embodiments, the alpha-amylase and protease enzyme is allowed to incubate with the sludge for 1 hour to 2 hours. In embodiments, the sludge is generated during conventional municipal and industrial wastewater treatment operations.

In embodiments, the present disclosure relates to a method of treating sludge including:
(a) contacting sludge with an alpha-amylase having at least 90% sequence identity to the alpha-amylase shown in SEQ ID NO: 1 and protease having at least 90% sequence identity to SEQ ID NO: 2; and
(b) removing water from the sludge. In embodiments, the alpha-amylase has at least 98% sequence identity to the alpha-amylase shown in SEQ ID NO: 1. In embodiments, the alpha-amylase has at least 99% sequence identity to the alpha-amylase shown in SEQ ID NO: 1. In embodiments, the protease has at least 98% sequence identity to the protease shown in SEQ ID NO: 2. In embodiments, the protease has at least 99% sequence identity to the protease shown in SEQ ID NO: 2. In embodiments, the alpha-amylase is the mature form of the alpha-amylase of SEQ ID NO:1, or functional fragments thereof and the protease is the mature form of the protease of SEQ ID NO:2.

The term “fragment” means a polypeptide having one or more (e.g., several) amino acids absent from the amino and/or carboxyl terminus of a mature polypeptide; wherein the fragment has activity.

### BRIEF DESCRIPTION OF THE DRAWINGS

FIG. 1 is a schematic view of wastewater treatment in accordance with the present disclosure.

### DETAILED DESCRIPTION OF PREFERRED EMBODIMENTS

The present disclosure relates to an enzymatic method to facilitate and/or improve the process of dewatering sludge, such as, sludge generated during conventional wastewater treatment.

The various processes to treat industrial and municipal wastewater often generate sludge as a by-product of proper operation. Sludges generated by the wastewater treatment industry are classified not only by the source of wastewater (e.g. municipal or industrial) but also by specific stages of the wastewater treatment process. In the broadest classification, sludge is considered primary, secondary or tertiary. Primary sludges are usually considered “raw” as they are often the result of settling of solids from raw wastewater influent passed across primary clarifiers. In most instances, the clarified water is then sent to activated sludge basins (ASBs) in which suspended flocs of microorganisms remove soluble contaminants from the water. As the microorganisms replicate, they must be periodically removed from the ASB to avoid overgrowth. Their removal takes place at a secondary clarifier receiving influent from the ASB. This “secondary sludge” is considered “waste activated sludge” (WAS) and has a relatively universal presence at WWTPs employing biological nutrient removal (BNR) systems. To reduce the volume of (and stabilize) this secondary sludge, the sludge may be sent to aerobic (ambient aeration or pure oxygen) or anaerobic digesters which may be operated under either mesophilic or thermophilic conditions. The resultant “tertiary” sludge is then known as “digested sludge” and may be further classified according to the specifics of digestion (e.g. thermophilic aerobically digested sludge). So, as can be seen, innumerable sludge types are produced during the treatment of wastewater. However, they can be loosely grouped as:
1. Primary or raw sludge;
2. Secondary or waste activated sludge; and
3. Tertiary, stabilized or digested sludge

Regardless of the means by which it was generated, sludge produced during wastewater treatment operations, usually employing some means of biological nutrient removal, will contain substances that serve as substrates for enzymatic hydrolysis. In most instances, this substrate is present as a component of the extracellular polymeric substances (EPS) that comprise the majority of the sludge solids. The composition of EPS varies from sludge to sludge depending upon a number of variables including the nature of the wastewater to be treated, the treatment process employed and the treatment conditions. Specific monosaccharides (e.g. glucose, mannose, galactose, etc.) tend to be universally present within sludge EPS. Considering this, although the overall composition of the EPS of sludge(s) may differ greatly, there is some degree of similarity in the type of glycosidic linkages present in the sludge components.

According to the present disclosure, alpha-amylase and protease compositions described herein can be applied to all sludge(s) associated with conventional wastewater treatment specifically to improve dewaterability. In a preferred embodiment, the alpha-amylase and protease enzymes and compositions thereof are applied to primary and secondary sludge(s) generated during treatment of industrial and municipal waste water. In embodiments, the alpha-amylase and protease and compositions thereof are applied to primary sludge from primary clarifiers, waste activated sludge, return activated sludge, aerobically digested sludge and/or anaerobically digested sludge. A purpose of the present disclosure is to facilitate or improve the process of sludge dewatering including treating sludge with an alpha-amylase and protease, prior to conventional sludge conditioning and dewatering operations.

The process to enhance the dewaterability of sludge according to the present disclosure comprises or consists of the following steps:
a) generating sludge, such as, during conventional wastewater treatment;
b) treating the sludge with an alpha-amylase enzyme and protease enzyme in accordance with the present disclosure;
c) optionally, conditioning the sludge with coagulating and/or flocculating additives;
d) dewatering the enzyme treated sludge with conventional equipment.

In addition to above steps further optional steps may be included, such as, for example, treating the sludge with enzymes both before and after digestion/stabilization stages. In embodiments, enzyme composition of the present disclosure is contacted with sludge before concentrating the sludge in the waste water process stream. In embodiments, enzyme composition of the present disclosure is contacted with sludge before mechanical dewatering of sludge in the waste water process stream.

Examples of suitable alpha-amylases for use in the enzyme treatment of the present disclosure are those derived from strains of Geobacillus (formerly Bacillus), e.g., Geobacillus stearothermophilus. As used herein, “derived from”, as in, e.g., “derived from a Geobacillus stearothermophilus” means a wild-type alpha-amylase enzyme and variants thereof. Such enzymes can also be prepared synthetically, as is well-known in the art.

In embodiments, the alpha-amylase is derived from a strain of Geobacillus stearothermophilus. In embodiments, the alpha-amylase is the commercial alpha-amylase enzyme composition AQUAZYM ULTRA™ 1200 (available from Novozymes North America, Inc. or Novozymes A/S) Suitable alpha amylases are described in PCT application nos. WO 96/23873 and WO 99/19467 herein incorporated by reference in their entirety. In embodiments, the alpha-amylase enzyme comprises an alpha-amylase having at least 50% sequence identity, at least 60% sequence identity, at least 70% sequence identity, at least 75% sequence identity, at least 80% sequence identity, at least 85% sequence identity, at least 90% sequence identity, at least 95% sequence identity, at least 96% sequence identity, at least 97% sequence identity, at least 98% sequence identity, or at least 99% sequence identity to a Geobacillus stearothermophilus alpha-amylase as shown in SEQ ID NO:1. For purposes of the present disclosure, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

In embodiments, the alpha-amylase is applied in amounts effective to facilitate or improve the process of sludge dewatering comprising contacting or treating sludge with an alpha-amylase, preferably, prior to conventional sludge conditioning and dewatering operations such as concentration and mechanical dewatering steps. Examples of suitable amounts include 2 to 140 g protein per kg of total suspended solids, 2 to 70 g of protein per kg of total suspended solids, 2 to 35 g of protein per kg of total suspended solids, 2 to 15 g of protein per kg of total suspended solids, 2-8 g of protein per kg of total suspended solids, and 2 to 5 g of protein per kg of total suspended solids. In embodiments, Aquazym® Ultra 1200 brand alpha-amylase is applied at 0.1-5 kg per dry ton of sludge solids. In embodiments, Aquazym® Ultra 1200 brand alpha-amylase is applied at 0.5-2 kg per dry ton of sludge solids. In embodiments, Aquazym® Ultra 1200 brand alpha-amylase is applied at 0.5 kg per dry ton of sludge solids.

The alpha-amylase may be applied under conditions suitable to the sludge processing conditions, such as, for example, temperatures from 5 to 40° C., pH conditions from 4 to 10, and for a treatment time of 0.5 to 30 hours, such as, 1 min. to 24 hours, 30 min. to 12 hours, and 1 hour to 2 hours.

In embodiments, the alpha-amylase is applied in combination with a protease in amounts effective to facilitate or improve the process of sludge dewatering comprising treating sludge with an alpha-amylase and protease, preferably, prior to conventional sludge conditioning and dewatering operations. Examples of suitable amounts of protease to combine with alpha-amylase include 2 to 140 g protein per kg of total suspended solids, 2 to 70 g of protein per kg of total suspended solids, 2 to 35 g of protein per kg of total suspended solids, 2 to 15 g of protein per kg of total suspended solids, 2-8 g of protein per kg of total suspended solids, and 2 to 5 g of protein per kg of total suspended solids. In embodiments, glutamic acid-specific protease is dosed at 0.1-5 g EP/DT. In embodiments, glutamic acid-specific protease is dosed at 1 g EP/DT (˜31 ppm).

In embodiments, the protease is derived from a strain of Bacillus licheniformis. In embodiments, the protease is the commercial protease enzyme composition glutamic acid-specific protease (available from Novozymes North America, Inc. or Novozymes A/S). In embodiments, suitable proteases are described in U.S. Pat. No. 4,266,031, WO 1991/13554, WO01/16285 and UNIPROT accession number P0C1U8. In embodiments, the enzyme composition comprises a protease having at least 50% sequence identity, at least 60% sequence identity, at least 70% sequence identity, at least 75% sequence identity, at least 80% sequence identity, at least 85% sequence identity, at least 90% sequence identity, at least 95% sequence identity, at least 96% sequence identity, at least 97% sequence identity, at least 98% sequence identity, or at least 99% sequence identity to a protease as shown in SEQ ID NO:2. For purposes of the present disclosure, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

In embodiments, the protease such as glutamic acid-specific protease is applied in amounts effective to facilitate or improve the process of sludge dewatering comprising treating sludge with an alpha-amylase and protease, preferably, prior to conventional sludge conditioning and dewatering operations including but not limited to concentration and mechanical dewatering. Examples of suitable amounts of protease include 2 to 140 g protein per kg of total suspended solids, 2 to 70 g of protein per kg of total suspended solids, 2 to 35 g of protein per kg of total suspended solids, 2 to 15 g of protein per kg of total suspended solids, 2-8 g of protein per kg of total suspended solids, and 2 to 5 g of protein per kg of total suspended solids. In embodiments, glutamic acid-specific protease is dosed at 0.1-5 g EP/DT. In embodiments, glutamic acid-specific protease is dosed at 1 g EP/DT (˜31 ppm).

The protease such as glutamic acid-specific protease may be applied under conditions suitable to the sludge processing conditions, such as, for example, temperatures from 5 to 40° C., pH conditions from 4 to 10, and for a treatment time of 0.5 to 30 hours, such as, 1 min. to 24 hours, 30 min. to 12 hours, and 1 hour to 2 hours.

The alpha-amylase/protease treatment in accordance with the present disclosure may also involve the addition of one or more additional enzymes. Preferred additional enzymes include a lipase, a cellulase, a hemicellulase, an oxidoreductase a laccase, another protease, a glycosyl hydrolase and/or an esterase.

In embodiments, treatments in accordance with the present disclosure are applied in the sludge conditioning step where polymers are being currently used. The enzymatic product is a consumable and will not require any hardware with it other than the capability to dispense it appropriately by the wastewater treatment plant. In embodiments, treatments in accordance with the present disclosure will completely replace polymer use in wastewater treatment. In embodiments, treatments in accordance with the present disclosure will reduce polymer use in wastewater treatment. In embodiments, the use of enzymes will be system/configuration agnostic. As long as a particular plant is conditioning the sludge prior to dewatering the proposed alpha-amylase/protease compositions in accordance with the present disclosure can be used.

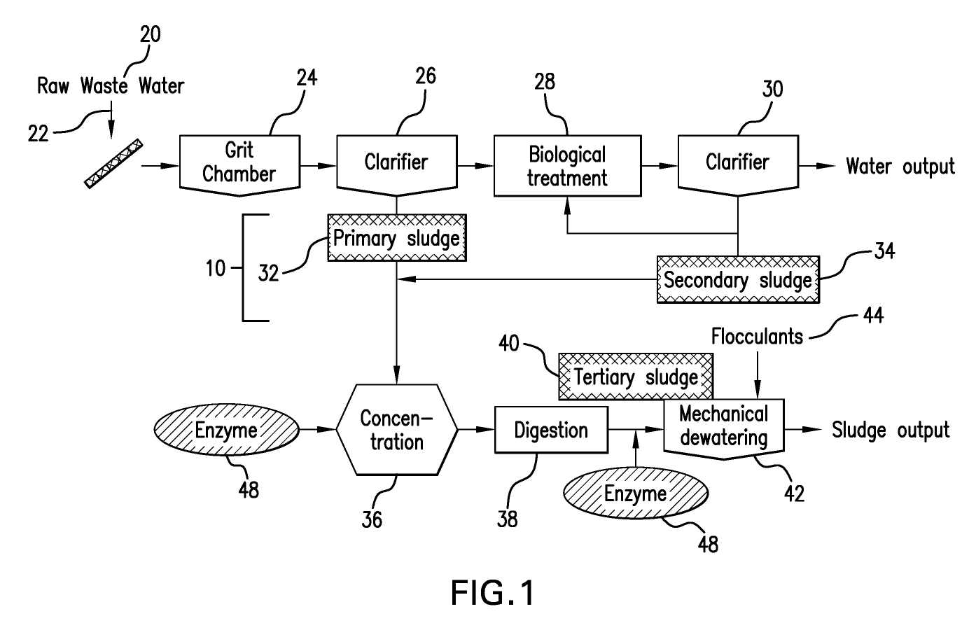

Referring to FIG. 1, a non-limiting schematic diagram of embodiments of the present disclosure is shown. Here, wastewater treatment (10) is shown where raw wastewater (20) enters treatment and forms a process stream (22). In a non-limiting example, process stream 22 flows through a grit chamber (24), clarifier (26), biological treatment (28) and clarifier (30) before either recirculating, exiting, or advancing down the process stream. Primary sludge (32) and secondary sludge (34) are shown advancing towards concentration (36). The sludge is shown entering digestion (38) and forming tertiary sludge (40) prior to mechanical dewatering (42), contact with flocculants (44) and sludge output (46). FIG. 1 shows enzyme (48) of the present disclosure being contacted with the process stream prior to concentration (36) and mechanical dewatering (42). FIG. 1 is non-limiting in that enzyme (48) in accordance with the present disclosure can contact the process stream before concentration and/or before dewatering. While not shown in FIG. 1, enzyme of the present disclosure can contact or be added to the process stream at any point in the process, and at various (multiple) points throughout the process.

In embodiments, and as shown in FIG. 1, the enzyme treatment is preferably added prior to sludge conditioning (i.e., prior to coagulation and/or flocculation) and mechanical dewatering.

### EXAMPLES

### Materials

Municipal sludge

Aquazym® Ultra 1200 brand alpha-amylase (available from Novozymes A/S) (SEQ ID NO:1).

Glutamic acid-specific protease (SEQ ID NO:2).

### Methods

Lab assay with scale of 300-500 mL were set up, in which positive press filter was used for s/L separation. Municipal sludge was analysed and found to have 42% w/w protein, 3.6% w/w glucan, 2.3% w/w xylan and 15.1% w/w acid insoluble substance.

Aquazym® Ultra 1200 brand alpha-amylase was applied at 0.5 kg per dry ton of sludge solids. Glutamic acid-specific protease was dosed at 1 g EP/DT (˜31 ppm). A summary of materials and methods is shown below:

Incubation was performed in a flask by adding enzyme of present disclosure in combination with sludge for 2 hr. at room temp.

Flocculation was performed as follows: Flocculants (CPAM, 0.3-0.5% g/g DM)

Dewatering: performed with press filter or rapid mixing centrifuge

Results (an amylase and a protease improved the dewaterability of sludge). Aquazyme-Alpha-amylase increased dewatered cake solids by 3.2% and reduced the weight of dewatered cake by 9.6% using 0.5 kg per dry ton of sludge solids.

Glutamic acid-specific protease dosing at 1 g EP/DT (˜31 ppm) increased dewatered cake solids by 2.5% and reduced the weight of dewatered cake by 7.4%.

The shear resistance of floc increased after glutamic acid-specific protease (NZ45001) addition at 0.2-2 ppm.

The dewaterability of sludge was poor when glutamic acid-specific protease(NZ45001) dosage was more than 10 g EP/DT.

It will be understood that various modifications may be made to the embodiments disclosed herein. Therefore, the above description should not be construed as limiting, but merely as exemplifications of embodiments. Those skilled in art will envision other modifications within the scope and spirit of the claims appended hereto. Moreover, terms should not be interpreted as implying any particular order among or between various steps herein disclosed unless and except when the order of individual steps is explicitly described.

1. A method for enhancing the dewaterability of sludge comprising adding an alpha-amylase and protease to the sludge, wherein the alpha-amylase has at least 90% sequence identity to the Geobacillus stearothermophilus alpha-amylase shown in SEQ ID NO: 1 and the protease has at least 90% sequence identity to SEQ ID NO: 2.

2. The method according to claim 1, wherein the alpha-amylase has at least 96% sequence identity to the alpha-amylase shown in SEQ ID NO: 1.

3. The method according to claim 1, wherein the alpha-amylase has at least 97% sequence identity to SEQ ID NO: 1.

4. The method according to claim 1, wherein the dose of alpha-amylase is between 2 and 140 g per dry ton of total suspended solids and the dose of the protease is between 2 and 140 g per dry ton of total suspended solids.

5. The method according to claim 1, wherein the dose of alpha-amylase is between 2 and 70 g per dry ton of total suspended solids and the dose of the protease is between 2 and 70 g per dry ton of total suspended solids.

6. The method according to claim 1, wherein the dose of alpha-amylase is between 2 and 35 g per dry ton of total suspended solids and the dose of the protease is between 2 and 35 g per dry ton of total suspended solids.

7. The method according to claim 1, wherein the dose of alpha-amylase is between 2 and 8 g per dry ton of total suspended solids.

8. The method according to claim 1, wherein the dose of alpha-amylase is between 2 and 5 g per dry ton of total suspended solids and the dose of the protease is between 2 and 5 g per dry ton of total suspended solids.

9. The method according to claim 1, wherein the alpha-amylase and protease enzyme is allowed to incubate with the sludge for 1 minute to 24 hours.

10. The method according to claim 1, wherein the alpha-amylase and protease enzyme is allowed to incubate with the sludge for 30 minutes to 12 hours.

11. The method according to claim 1, wherein the alpha-amylase and protease enzyme is allowed to incubate with the sludge for 1 hour to 2 hours.

12. The method according to claim 1, wherein the sludge is generated during conventional municipal and industrial wastewater treatment operations.

13. The method according to claim 4, wherein the sludge is selected from the group consisting of primary sludge from primary clarifiers, waste activated sludge, return activated sludge, anaerobically digested sludge and aerobically digested sludge.

14. The method according to claim 1, wherein the alpha-amylase and protease is added in combination with one or more lipases, cellulases, a hemicellulases, oxidoreductases, laccases, glycosyl hydrolases and/or an esterases.

15. The method of claim 1, wherein the alpha-amylase has alpha-amylase activity and the protease has protease activity.

16. A method of treating sludge comprising:
(a) contacting sludge with an alpha-amylase having at least 95% sequence identity to the alpha-amylase shown in SEQ ID NO: 1 and protease having at least 90% sequence identity to SEQ ID NO: 2; and
(b) removing water from the sludge.

17. The method of claim 16, wherein the alpha-amylase having at least 98% sequence identity to the alpha-amylase shown in SEQ ID NO: 1.

18. he method of claim 16, wherein the alpha-amylase having at least 99% sequence identity to the alpha-amylase shown in SEQ ID NO: 1.

19. The method of claim 16, wherein the alpha-amylase consists of the amino acid sequence of SEQ ID NO: 1.

20. The method of claim 16, wherein the protease has at least 98% sequence identity to SEQ ID NO: 2.

21. (canceled)
